(19) United States
(12) Patent Application Publication
(10) Pub. No.: US 2015/0036330 A1
(43) Pub. Date: Feb. 5, 2015

(54) FLASHLIGHT

(71) Applicant: James Economos, Kingston, NY (US)

(72) Inventor: James Economos, Kingston, NY (US)

(21) Appl. No.: 14/333,350

(22) Filed: Jul. 16, 2014

Related U.S. Application Data
(60) Provisional application No. 61/860,381, filed on Jul. 31, 2013.

(51) Int. Cl. F21L 4/08

(52) U.S. Cl. CPC F21L 4/08
USPC 362/183

(57) ABSTRACT

A user may use a flashlight as a portable light source by activating a light functionality of the flashlight, and directing the proximal portion of the flashlight towards an object or region that he wishes to illuminate. The user may also use the flashlight to charge other electrically-powered devices by connecting an electrically-powered external device to the flashlight through one or more of the connectors. The user may also recharge the flashlight by connecting an external power supply to the flashlight through one or more of the connectors.

### TECHNICAL FIELD

This disclosure relates to flashlights, and more particularly to flashlights adapted for charging electronic devices.

### BACKGROUND

Flashlights provide a hand-held portable source of light, and are often used in situations where hardwired power sources are not available or are otherwise inconvenient. Flashlights are commonly used in a wide array of applications, for example in activities related to work and industry, recreation, and emergency preparation.

### SUMMARY

In an aspect of the invention, a flashlight includes a power supply module configured to store electrical energy. The flashlight also includes an illumination source module connected to the power supply module through a switch. The flashlight also includes a charging module circuit configured for charging an external electrical device, the charging module circuit being directly connected to the power supply module.

In some implementations, the flashlight further includes a connection interface that connects the external electrical device to the power supply module. The connection interface can include a USB connector.

In some implementations, the illumination module source includes a light emitting diode.

In some implementations, the power supply includes a rechargeable battery. The rechargeable battery can be a lithium ion battery. The rechargeable battery can be a nickel metal hydride battery.

In some implementations, the power supply can store electrical energy at a voltage of at least 3.7 volts DC.

In some implementations, the external electrical device can be a cellular phone, a portable computing device, or a media player.

In some implementations, the charging module circuit is configured to discontinue charging of the external electrical device connected to the charging module circuit when the electrical energy stored in the power supply module falls below a pre-determined threshold value. The pre-determined threshold value can be a pre-determined fraction of an electrical energy storage capacity of the power supply module. The pre-determined threshold value can be about 10% of the electrical energy storage capacity of the power supply module. The flashlight can also include a circuit for recharging the power supply from a 5 volt source.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A and 1B show side views of an example flashlight.

FIGS. 1C-E show the different functions of the flashlight of FIGS. 1A-B.

FIG. 2 shows an exploded component view of one embodiment of the flashlight of the present invention.

FIG. 3 shows an exploded component view and wiring diagram of an example flashlight.

FIG. 4 depicts one embodiment of the flashlight of the present invention connected to a USB charging cable.

Like reference symbols in the various drawings indicate like elements.

### DETAILED DESCRIPTION

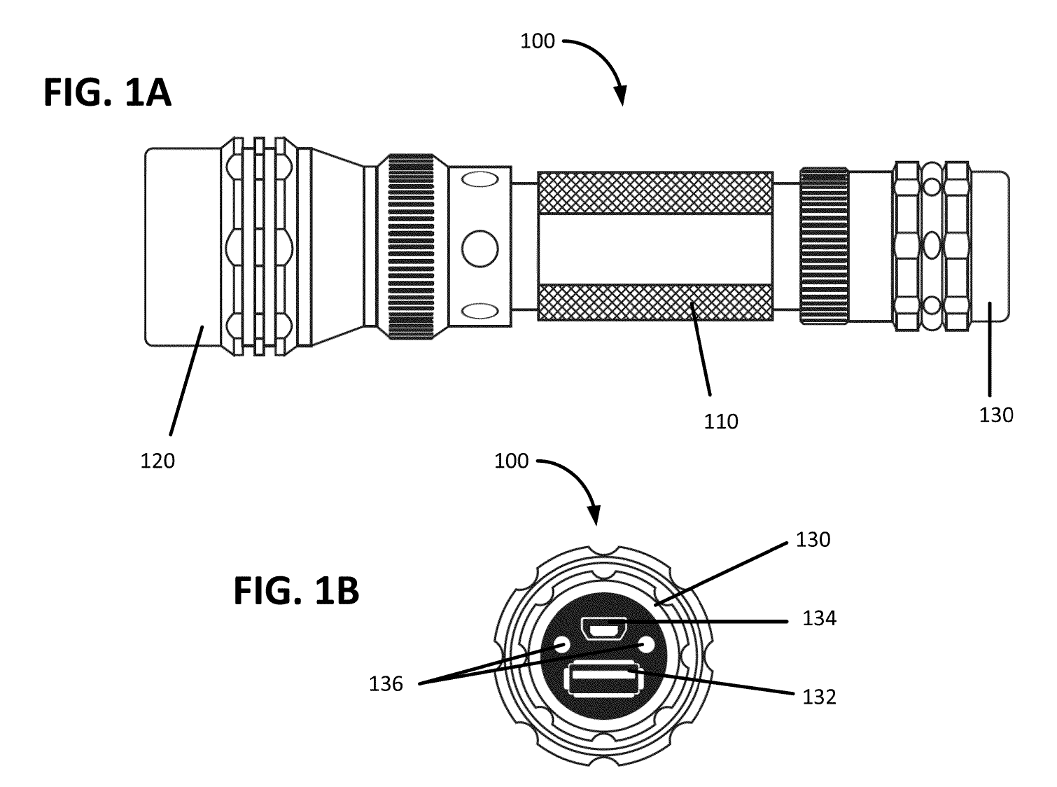

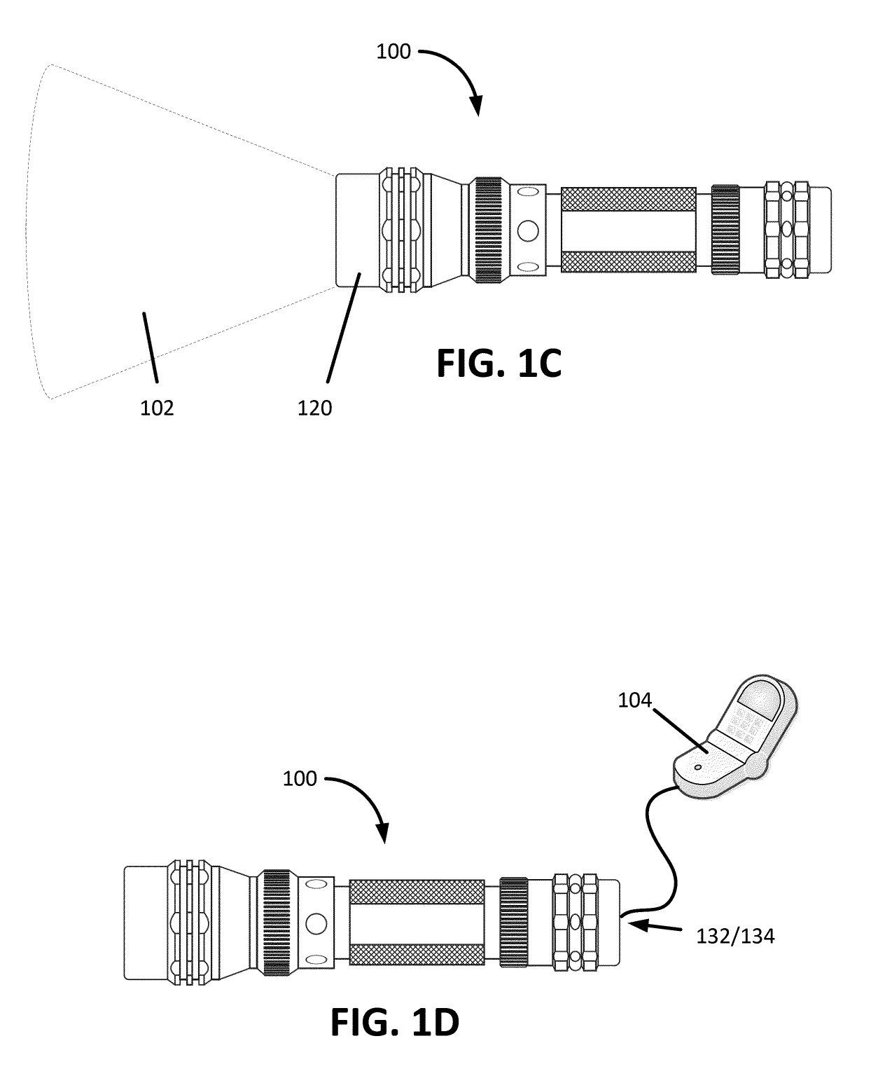

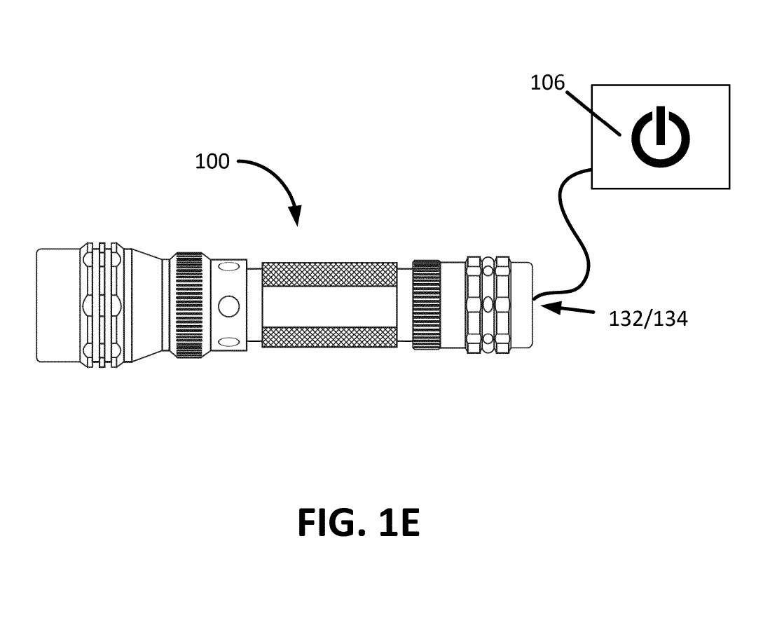

Referring to FIG. 1A, an example flashlight 100 includes a body region 110, a proximal region 120, and a distal region 130. Referring to FIG. 1B, the distal portion 130 includes connectors 132 and 134, and status indicators 136.

Flashlight 100 can be used in a variety of ways. For example, referring to FIG. 1C, a user may use flashlight 100 as a portable light source by activating a light functionality of flashlight 100, such that the flashlight 100 generates light 102. The user can then direct the proximal portion 120 towards an object or region that he wishes to illuminate.

As another example, referring to FIG. 1D, the user may also use flashlight 100 to charge an external electrically-powered device 104 (e.g., a cellular phone, personal data assistant (PDA), portable gaming device, portable computing device, etc.) by connecting an external electrically-powered device 104 to flashlight 100 through one or more connectors 132 and 134.

As another example, referring to FIG. 1E, the user may also recharge flashlight 100 by connecting an external power supply 106 to flashlight 100 through one or more of the connectors 132 and 134.

The user can use some or all of these functions, depending on his needs. For example, in one example of the use of flashlight 100, a user employs the light functionality in a conventional manner to illuminate a dark area, for instance during an outdoor activity when there is insufficient ambient light to comfortably see the surroundings. As the user is outside, and there is no wired power supply that is readily accessible, the user may use the charging functionality of the flashlight to recharge other electronic devices (e.g., to recharge a cellular phone). In other example usages, the user may use the light and/or charging functionalities of flashlight 100 when there has been an interruption of wired power, for instance during an emergency or disaster.

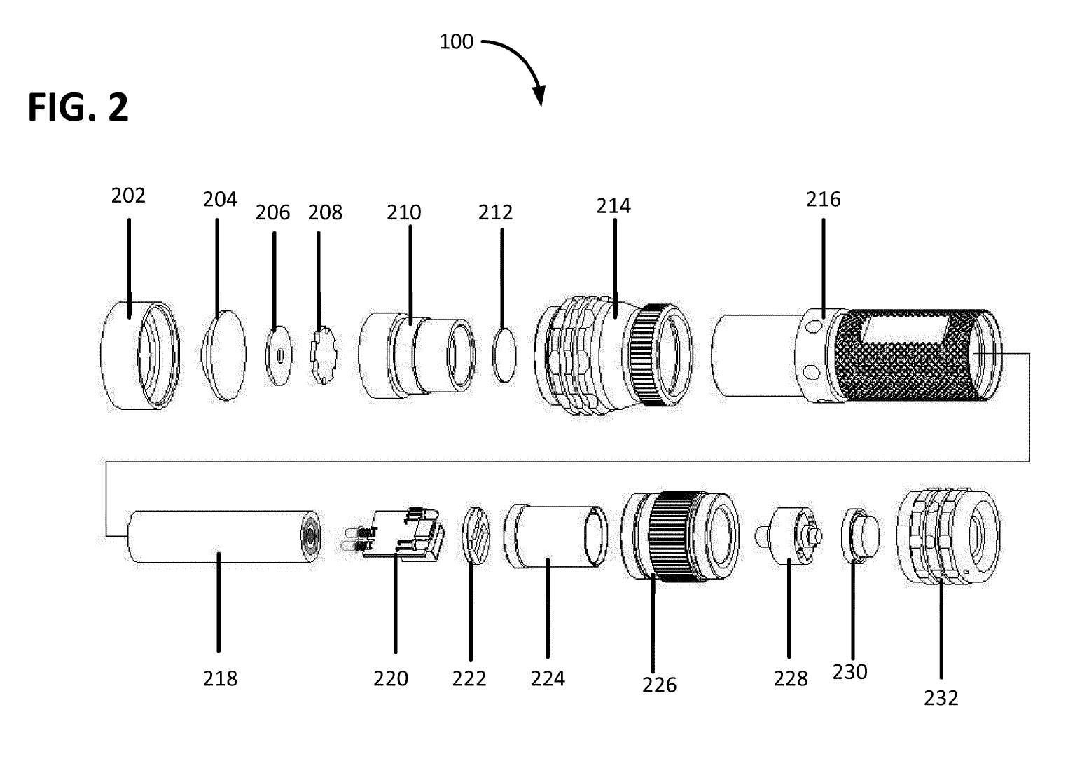

Referring to FIG. 2, an example implementation of flashlight 100 includes several components, for example a head ring 202, lens 204, press piece 206, lamp 208, LED stand 210, PCB 212, head part 214, barrel 216, power supply 218, recharge PCB 220, cover 222, pipes 224 and 226, switch 228, button 230, and tail part 232. These components provide a structural frame for flashlight 100, and provide the flashlight's illumination, external device charging, and recharging functionalities. Although an example implementation of flashlight 100 is shown in FIG. 2, this is provided merely as an example. Other combinations and arrangements of components can also be used, depending on the implementation.

The components may be secured to each other in various ways, for instance through threaded interaction between threaded portions of connected components, adhesive, fasteners, frictional fitting, or other connective mechanisms. For example, tail part 232 may be connected to pipe 226 through threaded connections on each, securing switch 228 and button 230 between them through a frictional fitting. Other components may be secured to each other using conventional mechanical arrangements.

In some implementations, one or more components of flashlight 100 may be releasably fastened, and may be attached and detached from the other components of flashlight 100. For instance, in some implementations, switch 228, button 230, and tail part 232 may be removed from flashlight 100 (e.g., unscrewed from the other components of flashlight 100) so that a user may access connectors 132 and 134. After the user is finished with connectors 132 and 134, he may reattach switch 228, button 230, and tail part 232 to flashlight 100. In this manner, a user may selectively attach and/or remove components from flashlight 100 based on his intended usage.

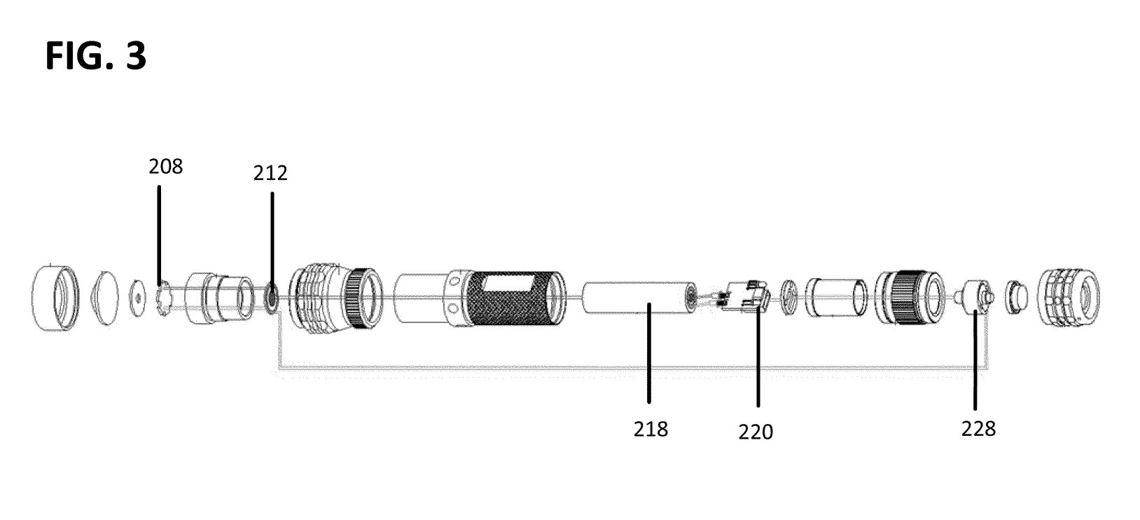

Referring to FIG. 3, components of flashlight 100 may be electrically connected such that electrical energy is distributed to one or more components of flashlight 100. For instance, an electrical circuit is formed by creating an electrically conductive path between the recharge PCB 220, the anode of power supply 218, PCB 212, and lamp 208, and by creating an electrically conductive path between the lamp 208, PCB 212, switch 228, recharge PCB 220, and the cathode of power supply 218. The electrically conductive path may be formed in various ways, for instance through an electrically conductive wire, an electrically conductive layer of one of more of the components of flashlight 100, or a combination of the two.

This electrical circuit may be interrupted by manipulating switch 228 in order to control the flow of electrical energy from power supply 218 to lamp 208. For example, a user may operate the light functionality of flashlight 100 by operating switch 228. In some embodiments, when the user applies an axial force to button 230, switch 228 is toggled, completing an electric circuit between power supply 218 and lamp 208 through PCB 220, thereby energizing lamp 208 with energy contained within power supply 218. While lamp 208 is energized, lamp 208 is illuminated, and the user may direct flashlight 100 towards areas that he wishes to illuminate. When the user wishes to shut off the illumination, he may any apply an axial force to switch 228, removing energy from lamp 208. Lamp 208 may be one of various types of components capable of providing illumination when energized. For instance, in some embodiments, lamp 208 is a light emitting diode (LED), for example a Cree T6 600 LED module. In some embodiments, lamp 208 is an incandescent light source. In some embodiments, lamp 208 may be a fluorescent lamp, a halogen lamp, an on organic LED, polymer LED, solid state light source, or any other type of light source. In general, LED lights are preferred due to their low level of power consumption and long life.

Power supply 218 stores energy within flashlight 100, and provides flashlight 100 with electric power to energize the light source and charge external devices. For instance, power supply 218 may be an electrical battery. In embodiments where flashlight 100 can be recharged, power supply 218 is rechargeable, and may be for instance a rechargeable battery. Power supply 218 stores sufficient energy, such that the user may use the light functionality and/or the charging functionality to perform the desired tasks. For instance, in some embodiments, power supply 218 is a 3.7 V with a capacity of 2000 mAh. In some embodiments, power supply 218 may be of different voltages (e.g. 1.5 V, 3 V, 6 V, 9 V, 12 V, etc.) and/or have different capacities (e.g., 1000 mAh, 3000 mAh, 4000 mAh, etc.) In some embodiments, power supply 218 may include more than one component for storing energy, for instance two batteries arranged in series or in parallel. In this manner, power supply 218 may have a voltage or energy storage capacity based on the combined operation of one or more individual energy storage components. Examples of power supply 218 may include one or more lithium ion batteries, lithium polymer batteries, nickel metal hydride batteries, nickel cadmium batteries, alkaline batteries, or any other type of energy storage components. In a preferred embodiment, power supply 218 is lithium ion rechargeable battery, having a voltage of 3.7 V and a capacity of at least 2000 mAh.

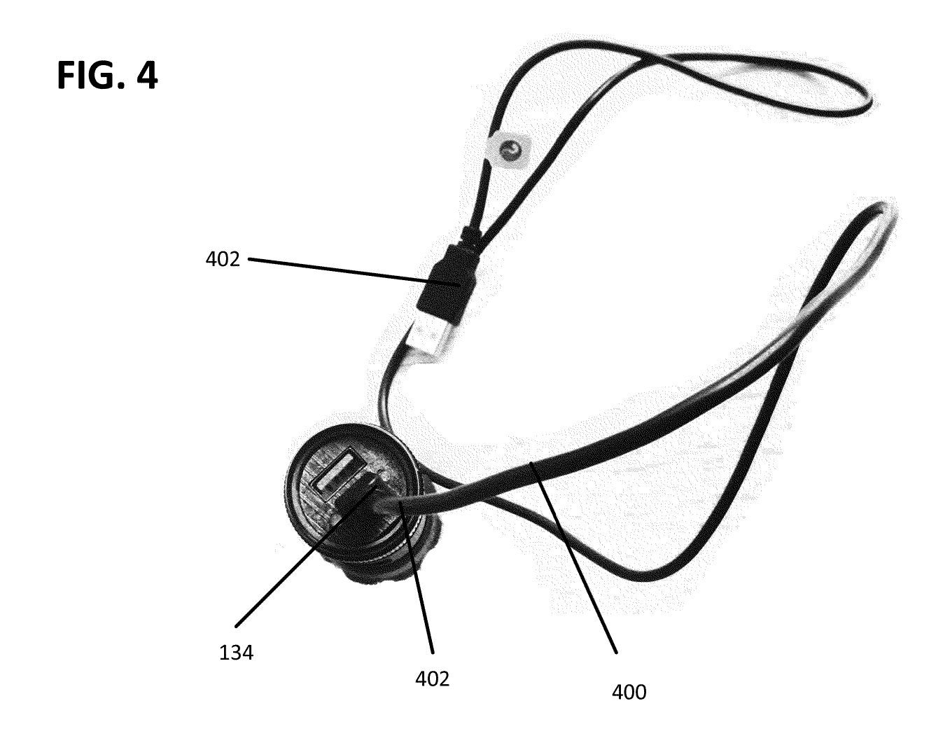

In embodiments where flashlight 100 may be recharged, flashlight 100 may be connected to an external power supply through connectors 132 or 134. For example, referring to FIG. 4, a user may connect a cable 400 by connecting cable interface 402 into connector 134. A second cable interface 406 may be connected into a corresponding connector of an external power supply. When the external power supply is connected in this manner, electrical energy from the external power supply is transferred to the power supply 218 of flashlight 100, recharging power supply 218.

In embodiments where flashlight 100 may recharge other devices, flashlight 100 may be connected to an external device through connectors 132 or 134. For example, again referring to FIG. 4, a user may connect a cable 300 by connecting cable interface 302 into connector 134. A second cable interface 406 may be connected into a corresponding connector of an external device. When the external device is connected in this manner, electrical energy from power supply 218 is transferred to the external device, recharging the external device.

Flashlight 100 may be used to charge a variety of external devices, including cellular phones, personal data assistants (PDAs), portable gaming devices, portable computing devices, media players, cameras, lights, radios, or any other device that can be charged using an external power supply.

In some embodiments, the power supply 218 may be of a different voltage than that of the external power supply or the external device. In these embodiments, the voltage may be adjusted by flashlight 100, such that it compatible with connected devices. This may be done through a component such as recharge PCB 220, which includes voltage conversion and regulation capabilities. For example, in some instances power supply 218 stores energy at a voltage of 3.7 V, while an external power supply provides energy at a voltage of 5 V. Recharge PCB 220 may transform the input voltage of 5 V into a voltage of 3.7 V, such that power supply 218 can be charged. In another example, the power supply 218 stores energy at a voltage of 3.7 V, while the external device requires energy at a voltage of 5 V to charge. Recharge PCB 220 may transform the power supply voltage of 3.7 V to an output voltage of 5 V, such that the external device can be charged. Although particular voltages are described in the above examples, these are provided merely to illustrate how voltage can be transformed between the power supply 218, an external power supply, and/or an external device. Other voltages can be used, depending on the implementation. As an example, in some implementations, the power supply 218 can store energy at a voltage of 3.7V, the external power supply can provide energy at a voltage of 12 V, and the recharge PCB 220 can transform the power supply voltage of 12 V into a voltage of 3.7 V, such that power supply 218 can be charged.

In some embodiments, the flashlight 100 can suspend charging operations when the amount of energy remaining in the power supply 218 has fallen below a particular threshold value (e.g., below 5% of the capacity of power supply 218, below 10% of the capacity of power supply 218, below 15% of the capacity of power supply 218, etc.) In some implementations, the PCB 220 can be used to provide this functionality. For example, during charging operations, the PCB 220 can monitor the amount of energy contained within the power supply 218. When it determines that the amount of energy remaining in the power supply 218 has fallen below a particular threshold value, the PCB 220 can stop the transfer of energy from the power supply 218 to the connected external device. In some implementations, stopping energy transfer in this manner ensures that a predetermined amount of energy in the power supply 218 remains available to operate the flashlight's illumination functionality, even if the connected external device has not yet been fully charged.

In general, connectors 132 and 134 allow for the transfer of energy into and/or out of flashlight 100. Connections 132 and 134 may be of various types of connection interfaces. For instance, in some embodiments, connectors 132 and 134 are universal serial bus (USB) connectors, such as USB Type A or B, mini USB Type A or B, micro USB Type A or B, nano USB Type A or B, etc. Connectors 132 and 134 may be adapted to accept different connect interface configurations. For instance, in some embodiments, one or more of the connectors are in a “male” configuration, such that they can connect to a connection interface in a “female” configuration. In some embodiments, one or more of the connectors are in a “female” configuration, such that they can connect to a connection interface in a “male” configuration. As shown in FIG. 1B, an embodiment of flashlight 100 includes a USB Type A connector 132 in a female configuration, and a mini USB Type A connector 134 in a female configuration. In some embodiments, instead of being of a common standard design, connectors 132 and 134 are of a propriety design, such that only cables with proprietary connection interfaces may be connected.

Connectors 132 and 134 may each differ in design such that flashlight 100 is compatible with devices and cables having different types of connection interfaces. For example, in some embodiments, connector 132 may be of one type of connector, type connector 134 may be of a different type of connector, such that flashlight 100 is capable of interacting with devices having any one of two types of connection interface designs. For example, as illustrated in FIG. 1B, flashlight 100 has a USB Type A connector 132 and a mini USB Type A connector 134, and is capable of interfacing with cables having either one of these configurations.

Connectors 132 and 134 may associated with either charging the flashlight, recharging external devices, or both. For example, in some embodiments, one connector 132 or 134 is dedicated solely to charging flashlight 100, while the other is dedicated solely to recharging external devices. In some embodiments, each connector 132 or 134 may be capable of both charging flashlight 100 and recharging an external device, depending on which type of device is connected. In some embodiments, a user may toggle between charging flashlight 100 and recharging an external device through a switch or other control. In some embodiments, flashlight 100 may have only a single connector. In some embodiments, flashlight 100 may have more than two connectors. In some embodiments, indicators may be used to indicate the operational state of flashlight 100. For instance, in some embodiments, indicators 136 may illuminate, flash, change color, or otherwise indicate the currently operational state of flashlight 100. For instance, one or more of the indicators 136 may be orange when lamp 208 is energized, red when flashlight 100 is being charged, and green when flashlight 100 is charging an external device. Other colors or patterns may be used to indicate the operational status of flashlight 100. Indicators 136 may be, for example, LEDs, OLEDs, LCD displays, audio speakers, any other type of component capable of conveying information to a user, or a combination of two or more of these components.

A number of embodiments of the invention have been described. Nevertheless, it will be understood that various modifications may be made without departing from the spirit and scope of the invention. Accordingly, other embodiments are within the scope of the following claims.

What is claimed is:

1. A flashlight comprising:
a power supply configured to store electrical energy;
an illumination source connected to the power supply through a switch; and
a charging circuit configured for charging an external electrical device, the charging circuit being connected to the power supply.

2. The flashlight of claim 1, further comprising a connection interface that connects the external electrical device to the power supply.

3. The flashlight of claim 2, wherein the connection interface comprises a USB connector.

4. The flashlight of claim 1, wherein the illumination source comprises a light emitting diode.

5. The flashlight of claim 1, wherein the power supply comprises a rechargeable battery.

6. The flashlight of claim 5, wherein the rechargeable battery is a lithium ion battery.

7. The flashlight of claim 5, wherein the rechargeable battery is a nickel metal hydride battery.

8. The flashlight of claim 1, wherein the power supply stores electrical energy at a voltage of at least 3.7 volts DC.

9. The flashlight of claim 1, wherein the external electrical device is a cellular phone.

10. The flashlight of claim 1, wherein the external electrical device is a portable computing device.

11. The flashlight of claim 1, wherein the external electrical device is a media player.

12. The flashlight of claim 1, wherein the charging circuit is configured to discontinue charging of the external electrical device connected to the charging circuit when the electrical energy stored in the power supply falls below a pre-determined threshold value.

13. The flashlight of claim 12, wherein the pre-determined threshold value is a pre-determined fraction of an electrical energy storage capacity of the power supply.

14. The flashlight of claim 12, wherein the pre-determined threshold value is about 10% of the electrical energy storage capacity of the power supply.

15. The flashlight of claim 12, further comprising a circuit for recharging the power supply from a 5 volt source.
